(19) United States
(12) Patent Application Publication
(10) Pub. No.: US 2004/0090125 A1
(43) Pub. Date: May 13, 2004

(54) Remotely activated electrical circuit

(76) Inventor: Antoniewski Bohdan, Tucson, AZ (US)

Correspondence Address: Mark E. Ogram, 7454 E. Broadway ste 203, Tucson, AZ, 85710, US

(21) Appl. No.: 10/291,090

(22) Filed: Nov. 8, 2002

(51) Int. Cl. H02B 1/24

(52) U.S. Cl. 307/112

(57) ABSTRACT

A system which uses a telephone system to remotely activate an electrical circuit. Using a remote telephone, the “ringing” signal causes an electrical circuit to initiate a timer which sends a signal for an operator specified amount of time to a relay switch. By closing the relay switch, electrical current is communicated for specified amount of time (ideally over five minutes in duration) to an electrical apparatus such as a light. This system allows a remote user to use the phone system to activates lights and other electrical apparatus at such sites as the user's home while the user is on vacation, or maintenance personnel activating parking lot lights.

### BACKGROUND OF THE INVENTION

This invention relates generally to electrical circuits and more specifically to remotely activated electrical circuits.

The ability to remotely activate electrical circuits is a difficult problem to solve, whether the application is in the home or in the industrial/commercial setting. Although there are several “hard wire” solutions, these are often expensive or prohibitive to use.

As example, when a home owner arrives late at night at their residence, they often want to have a lighted dwelling to enter. While motion sensors are available to light the parking area as the vehicle approaches the house, there isn't any practical way that the driver of the vehicle can remotely activate a light within the house. This means that the home owner must enter the dwelling in the dark, thereby exposing the home owner to unnecessary dangers.

The problem for the home owner is also present when the home owner is absent from their home for several days (i.e. on vacation). To reduce the chance of a burglar recognizing that the dwelling is not occupied, timers are often employed routinely to activate lights and televisions. Unfortunately, timers operate on a set pattern which the burglar can easily discern.

Within the industrial or commercial settings the need to remotely activate electrical circuits is also acute. Often there is a need to have an operator activate outdoor lights or heating/cooling mechanisms. Typically this is done by “hard wiring” a switch. The operator is then forced to travel to the switch for the activation of the outdoor lights.

It is clear there is a need for an efficient and easily installed remote activation mechanism.

### SUMMARY OF THE INVENTION

The invention is a system which uses a telephone system to remotely activate an electrical circuit. While much of the present discussion relates to the use of the invention within the home setting, the invention is not so limited and is intended to be used by a variety commercial and industrial settings as well.

Telephone systems are well established and include both traditional land lines and cellular phone systems. When a remote phone initiates a connection, the local telephone site receives an incoming call signal is traditionally used to activate a ringer.

Within this invention, at the local telephone site, the “ringing” signal causes an electrical circuit to initiate a timer. The timer generates a signal for a specified amount of time. In the preferred embodiment, the time lapse is set by the operator.

The signal from the timer is communicated to a relay switch which closes. The relay switch receives its base power from the normal electrical circuit at the site (in the case of a home, 120 volts, 60 hertz current). In the industrial/commercial setting, the source electrical current is often of much higher to accommodate the requirements of the apparatus being powered through the relay switch (often 240 volts, 60 hertz).

In this way, the incoming telephone signal “activates” the local apparatus for a specified amount of time. By closing the relay switch, electrical current is communicated for a specified amount of time (ideally over five minutes in duration) to an electrical apparatus such as a light.

The remote activation of the electrical apparatus permits a wide range of applications, including but not limited to: the activation of lights within a dwelling prior to the home owner entering the dwelling; activating lights while the home owner is away on vacation; remotely activating heating/cooling systems before the staff arrive at work; and, allowing maintenance personnel to activate parking lot lights without having to travel to the site.

In one application, the lighting of parking lot lights and heating/cooling activation is accomplished using a computer system with modem. The computer selectively dials a list of phone numbers at selected times. In this application, a central monitoring business (such as a security agency) from a central location is able to provide an additional service for their clients by activating the heating/cooling, or lighting the parking areas of businesses. This type of service is ideally national in scope as no long distance charges are incurred; the relay switches are activated on the first “ring” signal, prior to the phone being “answered”.

Because the activation is done via a phone system and not an Internet connection, problems from hackers is reduced significantly.

Within the home setting, an embodiment of the invention includes a clock setting permitting the operator to select the time of day when the activation is accepted. This allows the operator to keep the lights from being activated during the day or while they sleep.

In yet another embodiment, a switch permits the operator to disconnect the system from the phone system; thereby allowing, the operator to keep the lights from being activated by “wrong numbers”.

In some embodiments, the local apparatus includes the ability to close the relay switch only when the incoming call is from specified phones. This is typically accomplished using a data base of acceptable phone numbers which are compared to the incoming call identification.

The invention, together with various embodiments thereof, will be more fully explained by the accompanying drawings the following descriptions thereof.

### DRAWINGS IN BRIEF

FIG. 1 is a functional block diagram of the invention.

FIG. 2 is a block diagram of the preferred embodiment of the invention.

FIG. 3 illustrates the housing configuration for the preferred embodiment of the invention.

FIG. 4 illustrates an embodiment of the invention installed during the construction of a building.

FIG. 5 illustrates an alternative embodiment of the invention.

FIGS. 6A and 6B illustrate embodiments of the invention which are used within the commercial/industrial setting.

FIGS. 7A and 7B illustrate an embodiment of the invention which is operational only during times set by the operator.

FIG. 8 is a flowchart for establishing a database for use in screening the phones which can activate the present invention.

FIG. 9 is a flowchart of the operation of the embodiment of the invention in which a central computer selectively activates remote electrical systems.

### DRAWINGS IN DETAIL

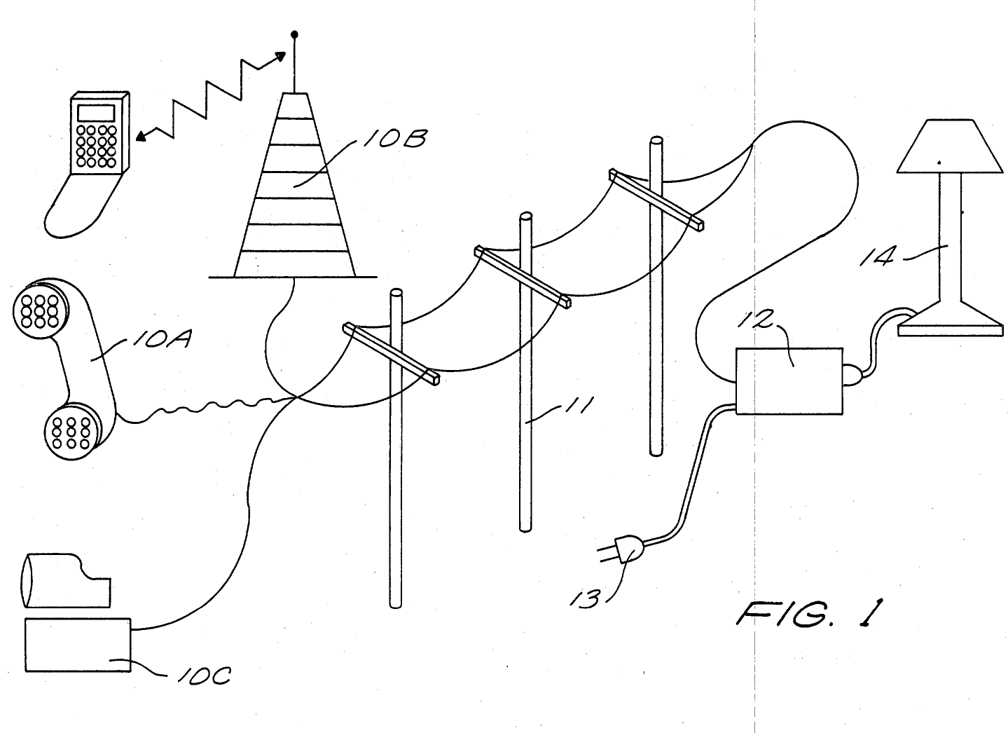

FIG. 1 is a functional block diagram of the invention.

Phone system 11 is activated through a variety of techniques, including, but not limited to: traditional telephone 10A; cell phone system 10B; or computer (with modem) 10C. Any of these devices use phone system 11, to initiate a connection with receiver 12.

Receiver 12 receives its power, in this embodiment, via electrical connector 13. Upon the initiation of the telephone connection with receiver 12, the relay switch (not shown) is closed allowing the electrical current to flow from electrical connector 13 to light 14, thereby activating light 14.

In this matter, light 14 is selectively activated by any of the remote devices (telephone 10A, cell phone 10B, or computer 10C).

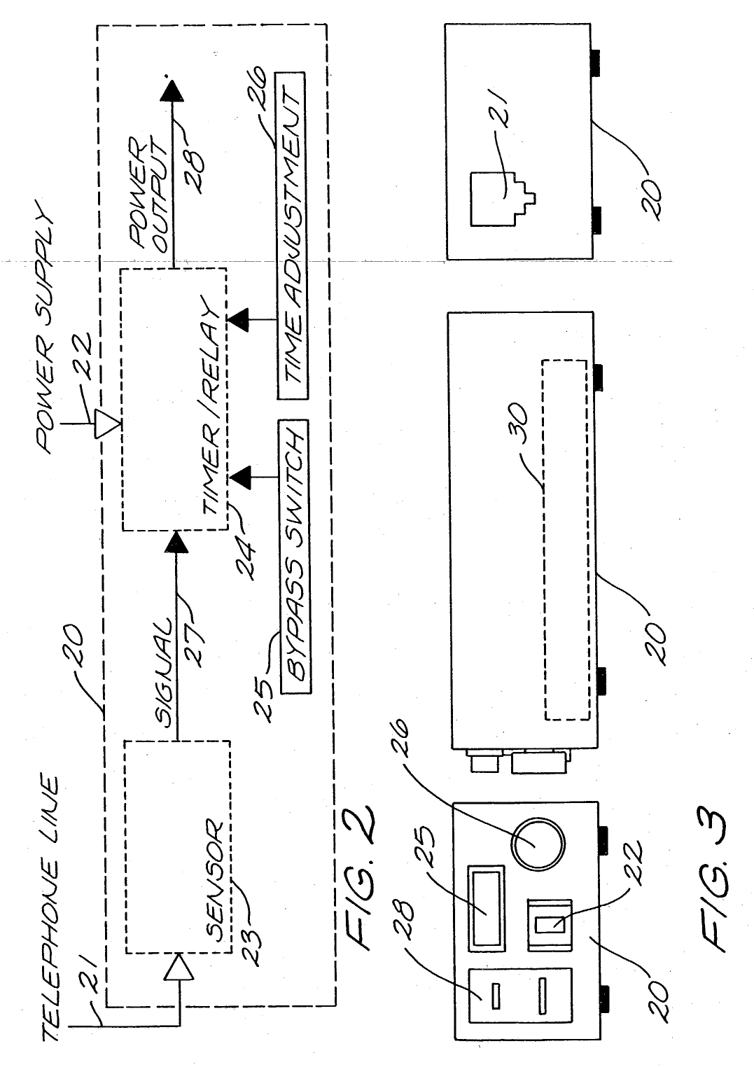

FIG. 2 is a block diagram of the preferred embodiment of the invention.

Housing 20 receives input from telephone line 21 and external power supply 22. Telephone line 21 communicates with sensor 23 which ideally is a high sensitivity alternating current relay with isolating dry contacts. Sensor 23 reacts the incoming signals from telephone line 21 and communicates signal 27 to timer/relay 24.

Timer/relay 24 closes an internal relay switch so that electrical power 22 is communicated to output 28 which is used to activate a remote light or other electrical apparatus.

Timer/relay 24 is also selectively activated by the operator using bypass switch 25.

The amount of time during which relay 24 is closed after activation is defined by the user through time adjustment 26. In this manner, the user is able to define the amount of time which the electrical apparatus is activated. In the preferred embodiment, this timing has a lower limit of five minutes in different perspectives.

FIG. 3 illustrates the housing configuration for the preferred embodiment of the invention.

Enclosure 20 is configured to house the switching and sensing mechanism 30 of the present invention. Power is communicated via power cord input 22; the electrical apparatus is connected to receptacle 28.

Should the operator want to bypass the sensor, bypass switch 25 permits easy activation of the electrical apparatus.

The time period for activation of the electrical apparatus is set by the operator through knob 26.

The phone line is connected at telephone line jack 21.

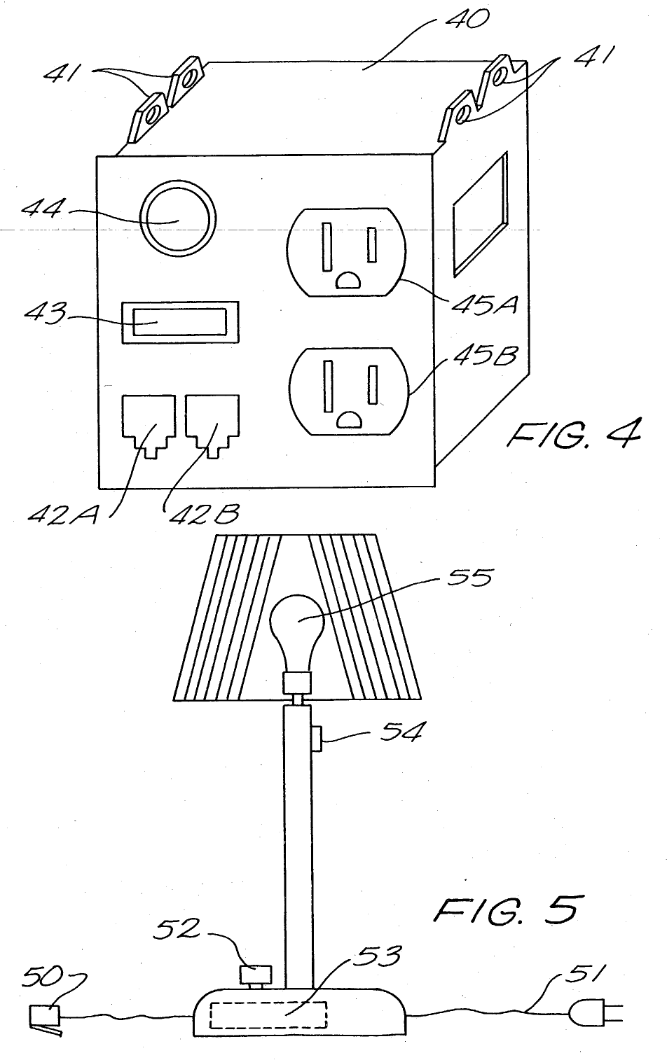

FIG. 4 illustrates an embodiment of the invention used during the construction of a building.

During the construction of the dwelling, office, or other such building, connection box 40 is secured into the wall using anchors 41. The power and telephone lines (not shown) are installed into connection box 40 and are connected to the internal circuitry as outlined above. The sensing and relay circuitry are not shown in this illustration, but the operation is as outlined above.

In this embodiment, a single unit provides the user with all of the capabilities as outlined above and which is secured into the wall of the dwelling. This includes the time adjustment knob 44, the bypass switch 43 and the controlled receptacle 45B. Controlled receptacle 45B is connected to the lamp and is to be remotely activated by the incoming telephone line.

The household electrical wiring provides constant power to receptacle 45A, thereby allowing the user to connect another appliance (i.e. a clock) so that power is continuously applied.

Telephone jacks 42A and 42B allows the user to connect a telephone and/or a fax to the apparatus and to use the installed phone line.

FIG. 5 illustrates an alternative embodiment of the invention.

This embodiment of the invention encases the electronic components 53 for sensing and relay within a lamp assembly. Telephone line 50 and power cord 51 are connected to their appropriate outlets. Time adjustment know 52 is easily accessible for the user to define the time lapse for the activation of bulb 55 as outlined above.

On-off switch 54 serves as a bypass switch allowing the user to selectively activate bulb 55 independent of the electronic components 53.

FIGS. 6A and 6B illustrate embodiments of the invention.

These embodiments are illustrated without any timing mechanism as they are intended to be both activated and de-activated by phone. Variations on these embodiments include timers which are installed internally to avoid any modifications once installed.

Referring to FIG. 6A, power source 60A is connected to the sensor/relay 61A which is controlled by phone line 63A as outlined above. When an incoming telephone signal is sensed by sensor/relay 61A, the relay is closed and the electrical current is communicated to the external electrical apparatus 62A (i.e. heating/cooling or lighting system).

The embodiment of FIG. 6B also receives source electrical current 60B to sensor/relay 61B. In this embodiment, cell receiver 63B is used to receive the incoming telephone signal and close the relay, thereby communicating the electrical current to the external electrical apparatus 62B.

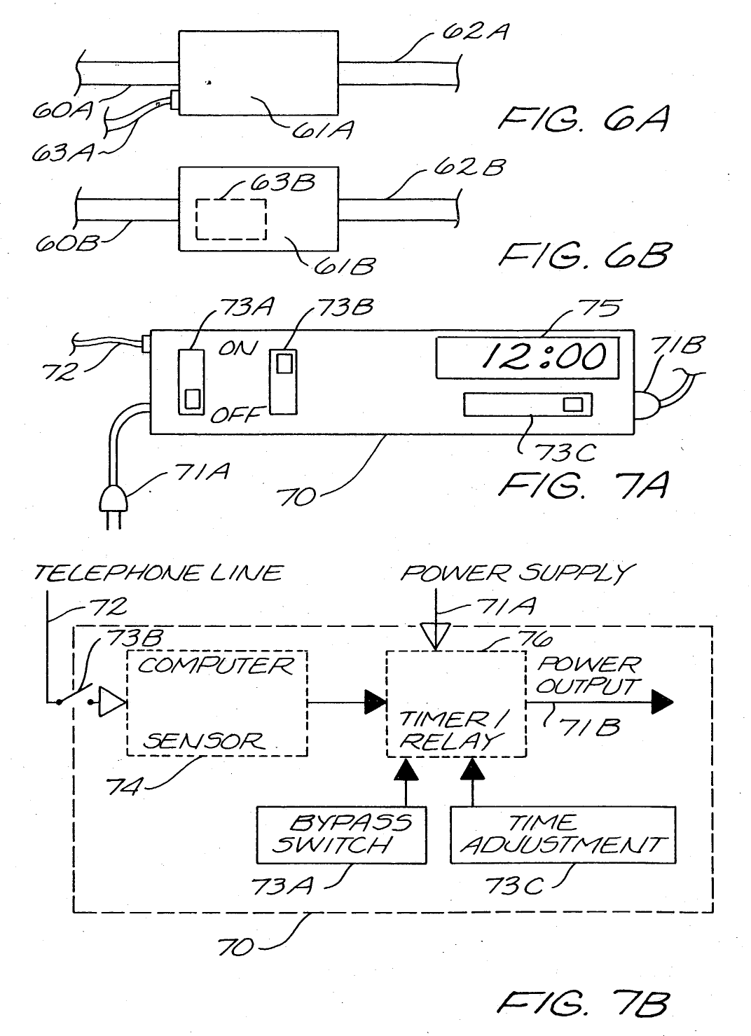

FIGS. 7A and 7B illustrate an embodiment of the invention which is operational only during periods set by the operator.

Telephone line 72 is connected to switch 73B. Switch 73B is used in this embodiment to disconnect the unit, thereby rendering the remotely activated system inoperable. Switch 73B allows the operator to keep the “lights” from being activated at inconvenient times (such as when the user is home).

If switch 73B is closed, then the incoming phone signal is received by computer/sensor 74. Computer/sensor 74 checks the identification of the telephone making the call against a database of “authorized” phone I.D.s' to see if it is one of the phones authorized to remotely activate the lights.

If the remote phone is “authorized”, computer/sensor 74 activates timer/relay 76 which closes the internal relay allowing the power from power supply 71A to flow through to power output 71B.

Timer/relay 76 also uses time adjustment 73C in establishing the amount of time the internal relay is closed.

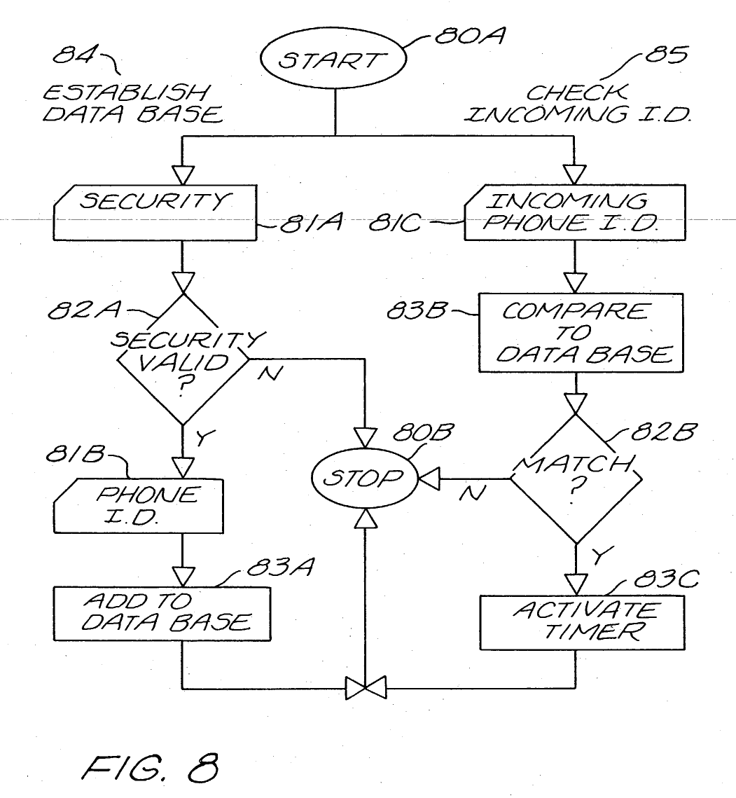

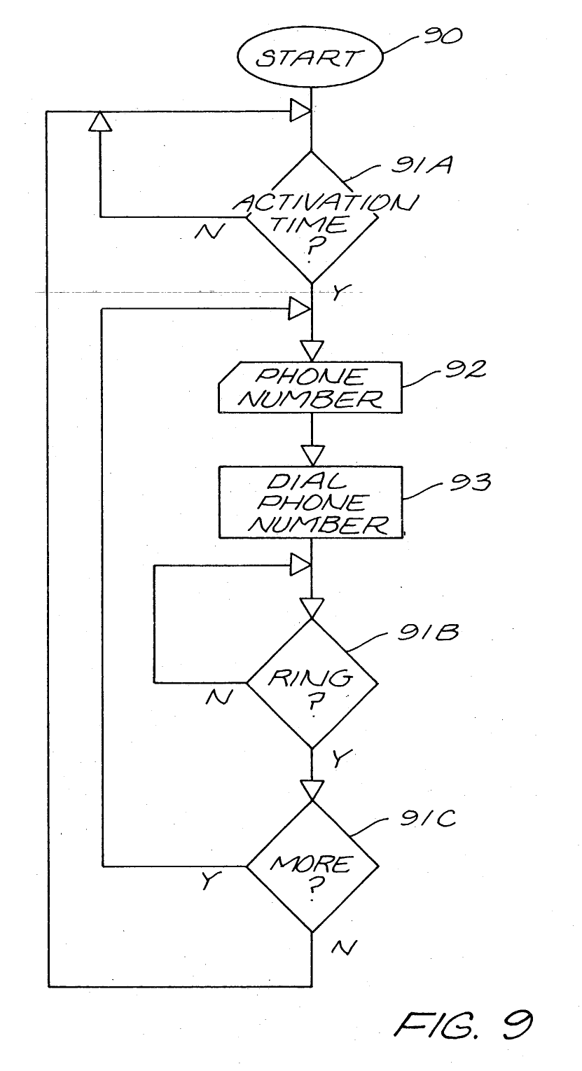

FIG. 8 is a flowchart for establishing a database for use in screening the phones which can activate the present invention.

After the program starts 80A, the program can either establishes the data base 84 or checks the incoming phone call against the database 85.

The data base is established 84 by first accepting the security clearance 81A from the operator. Ideally this is accomplished by using a predefined sequence of numbers which the operator transmits from the desired remote phone. If the security clearance is not valid 82A, the program stops 80B.

If the security is valid 82A, then the phone identification is obtained 81B from the remote phone and is added to the database 83A. The program then stops 80B.

For an incoming phone call 85, the incoming phone identification is obtained 81C and is compared to the acceptable identifications 83B from the database. If no match occurs 82B, then the program stops 80B; otherwise, the timer/relay is activated 83C and the program stops 80B.

FIG. 9 is a flowchart of the operation of the embodiment of the invention in which a central computer selectively activates remote electrical systems.

After the start 90 of the program, a check 91A is made to see if it is the proper time to activate the remote electrical systems. If it isn't, the program cycles back to continue monitoring the time.

At the proper time, 91A, the stored phone number 92 is pulled from memory and is dialed 93. A check to see if the remote phone is ringing 91B is made. Upon a completed ring, the system knows that the remote electrical system has been activated, the next phone number is sought 91C. The process continues until all of the phone numbers within the database have been used. At this point, the program returns to monitor the time 91A again.

It is clear from the foregoing that the present invention provides for an efficient and cost-effective remotely activated switch.

What is claimed is:

1. A remotely activated electrical circuit comprising:
a) a sensor communicating an electrical signal in response to an incoming telephone signal;
b) a timer mechanism, said timer mechanism having a time lapse mechanism adjustable by an operator and generating a signal for a selected period of time after activation in response to the electrical signal from said sensor;
b) a relay switch receiving electrical current, said relay switch closing in response to the signal from said timer mechanism.

2. The remotely activated electrical circuit according to claim 1, further including an operator controlled override switch configured to selectively activate said relay switch.

3. The remotely activated electrical circuit according to claim 2, further including means for preventing said sensor from receiving said incoming telephone signal.

4. The remotely activated electrical circuit according to claim 3, wherein said means for preventing includes clock means for preventing said incoming telephone signal during an operator specified range of time.

5. The remotely activated electrical circuit according to claim 1, wherein said sensor includes:
a) means for identifying an incoming telephone signal; and,
b) means for comparing a remote telephone identification on the incoming telephone signal with a preset data base of identifications; and,
c) means for activating said timer mechanism only if said remote telephone identification matches one of said identifications in said data base.

6. The remotely activated electrical circuit according to claim 5, further including means for operator establishment of data within said data base.

7. The remotely activated electrical circuit according to claim 6, wherein said means for establishing data within said data base includes:
a) means for receiving an identification of a telephone after a security clearance has been received; and,
b) means for storing said identification of a telephone in said data base.

8. The remotely activated electrical circuit according to claim 1, further including a housing containing said sensor, said timer mechanism, and said relay switch.

9. The remotely activated electrical circuit according to claim 8, wherein said housing includes:
a) means for mounting said housing in a wall of a building;
b) a telephone outlet configured to connect a telephone to a telephone system; and,
c) at least one electrical outlet.

10. The remotely activated electrical circuit according to claim 9, wherein one of said at least one electrical outlets is controlled by said timer mechanism.

11. The remotely activated electrical circuit according to claim 10, wherein one of said at least one electrical outlets is independent of said timer mechanism.

12. The remotely activated electrical circuit according to claim 1, further including a light mechanism activatable by relay switch.

13. An electrical switch comprising:
a) a circuit having a timer mechanism reacting to an incoming telephone signal and generating an activation signal for a selected period of time thereafter; and,
b) a relay switch receiving electrical current, said relay switch closing in response to the activation signal.

14. The electrical switch according to claim 13, further including an override switch configured to selectively activate said relay switch.

15. The electrical switch according to claim 13, further including a housing containing said circuit and said relay switch.

16. The electrical switch according to claim 15, wherein said housing includes:
a) means for mounting said housing within a wall of a building;
b) a telephone outlet configured to connect a telephone to a telephone system; and,
c) at least one electrical outlet.

17. The electrical circuit according to claim 16, wherein one of said at feast one electrical outlets is controlled by said relay mechanism.

18. The electrical circuit according to claim 13, further including a light mechanism activatable by relay switch and containing said circuit and said relay switch.

19. An electrical system comprising:
a) a telephone system communicating electrical signals between two telephone destinations; and,
b) an electrical circuit located at a first destination of said telephone system, said electrical circuit comprising:
1) a tinier mechanism responding to an initial electrical signal from a remote telephone via said telephone system, said timer mechanism initiating an activation signal for a pre-determined lapse of time greater than five minutes, and,
2) a relay switch closing in response to said activation signal, thereby connecting an electrical apparatus with an electrical current.

20. The electrical system according to claim 19, wherein said electrical circuit further includes an operator controlled override switch configured to selectively activate said relay switch.

21. The electrical system according to claim 20, further including a housing containing said electrical circuit and said relay switch.

22. The electrical system according to claim 21, wherein said electrical apparatus includes a light emitting apparatus and which is secured to said housing.

23. The electrical system according to claim 19, further including a computer having means for initiating a connection between said computer and said electrical circuit via said telephone system at an operator selected time.
